(19) United States
(12) Patent Application Publication
(10) Pub. No.: US 2010/0078558 A1
(43) Pub. Date: Apr. 1, 2010

(54) Infra-red light stimulated cdZnTe spectroscopic semiconductor x-ray and gamma-ray radiation detector

(76) Inventors: Michael Prokesch, Gibsonia, PA (US); Csaba Szeles, Allison Park, PA (US)

Correspondence Address: Mark Levy;Hinman, Howard & Kattell, LLP, 700 Security Mutual Bldg., 80 Exchange Street, Binghamton, NY, 13901, US

(21) Appl. No.: 12/586,655

(22) Filed: Sep. 25, 2009

Related U.S. Application Data
(60) Provisional application No. 61/100,364, filed on Sep. 26, 2008.

(51) Int. Cl. G01J 5/00

(52) U.S. Cl. 250/338.1

(57) ABSTRACT

A method of detecting radiation by which residence time of charge carriers is dramatically reduced by an external optical energy source and the occupancy of deep-level defects is maintained close to the thermal equilibrium of the un-irradiated device at any temperature. The energy of an infra-red light source is tuned within a predetermined band gap energy range and crystals are transparent to the infra-red light of the energy. Thus, other than the one associated with the ionization of the target deep-level defects, no other absorption occurs. Because of this low absorption, infra-red irradiation can be performed through any surface of the crystal that is transparent to the infra-red light which allows irradiation geometry from any side surface(s) of the detector crystals.

### RELATED APPLICATION

The present patent application is a continuation-in-part of U.S. provisional patent application Ser. No. 61/100,364, filed Sep. 26, 2008, hereby incorporated, and claims the priority date thereof.

### FIELD OF INVENTION

The present invention relates to detecting radiation, and more specifically, to a method by which the residence time of charge carriers is dramatically reduced by an external optical energy source.

### BACKGROUND OF THE INVENTION

Historically, semi-insulating Cd₁₋ₓZnₓTe (where 0≦x<1) crystals with Zn composition in the 0≦x≦0.25 mole fraction range are typically used for room-temperature semiconductor radiation detector applications. In order to be useful for x-ray and gamma-ray detectors, the Cd₁₋ₓZnₓTe crystals must be electrically compensated to bring them to a highly resistive state so that the equilibrium residual free carrier concentration is much lower than that of the free carriers generated by the impinging x-rays and gamma-rays. The high-resistivity state can be achieved by various doping recipes that are described in numerous publications and patents. All of these doping methods work on the principle of deep-level defect electrical compensation. Using this method, a relatively modest amount of deep-level defects is incorporated near the middle of the band gap of the Cd₁₋ₓZnₓTe crystals.

Usually, the performance of Cd₁₋ₓZnₓTe detectors is determined by the charge transport properties of free electrons and holes generated during the interaction of the detector material with the impinging x-ray or gamma-rays. Defect levels capture the generated free carriers and deteriorate the proportionality between the deposited x-ray and gamma-ray energy and the signal amplitude. Charge carriers trapped at defect levels in the band gap of the semiconductor spend a finite time at the defect level before they either escape in a thermally stimulated process or recombine with a carrier of opposite type.

The residence time of a carrier in a defect with a given capture cross-section depends on the position of the defect level in the band gap and on the available density of states in the band it communicates to. At room temperature, the residence time on shallow levels that are located only ˜10-100 meV from the band edges is on the order of picoseconds (10⁻¹² s) range. For mid-depth defects with energy levels ˜0.3-0.4 eV from the band edges, the residence time is in microseconds (10⁻⁶ s). For deep-level defects in the middle of the band gap, the residence time is in the 0.0001-1.0 seconds range. Additionally, under lower temperature operating conditions, the emission rates of trapped carriers from the defects back to the conduction or valence band are dramatically reduced. A space charge can build up in the detector device even under low-flux conditions causing deterioration or collapsing of the spectral response.

As deep-level defects are used for the electrical compensation to achieve the high resistivity of CdZnTe crystals, their elimination by defect engineering and appropriate process control during crystal growth and post-growth thermal annealing is not a viable approach. The built-in deep-level defects therefore necessarily give rise to a deterioration of the spectral performance. The energy needed for the trapped electrons and holes at deep level defects is large compared to the available thermal energy. As a result, the probability to acquire the necessary thermal energy is low resulting in long residence time of the carriers in the trapped state.

Currently, no outside light stimulated low-flux spectroscopic CdZnTe detector devices are patented, proposed, discussed in the literature, designed, or sold in the marketplace. This active light stimulation and the infra-red radiation tuned in energy to specific deep-level defects are the core ideas of this invention.

Reduced residence time of the carriers at the deep defect levels achieved by infra-red radiation in the current invention benefits the performance of the detector device in a number of ways. First, in spectroscopic applications (using electron-only device configurations) or in Single-Photon Emission Computed Tomography, the performance of CdZnTe detectors is limited by the electron trapping on deep-level defects. By suppressing electron trapping on the defects, the performance of these detectors (e.g., their energy resolution and image uniformity) can be significantly improved. However, in detector configuration in which the spectral resolution is limited by charge transport non-uniformities over the active area of the detector (e.g., in coplanar grid detectors), the energy resolution can be improved. Also, in detector configurations where hole trapping leads to significant deterioration of the spectra, such as medium and high energy gamma-spectroscopy with planar detectors, improvements of the spectroscopic performance can be achieved. Lastly, under lower temperature operating conditions (e.g., for noise suppression) space-charge formation and collapsing spectra can be avoided and the detector operation can be recovered. These benefits of the invention lie in the active control of the steady-state occupancy of deep-level defects by using a suitably tuned infra-red light source to (1) improve the low-flux x-ray and gamma-ray spectroscopic performance (i.e., resolution) of the detector devices, and (2) extend their operating range to lower temperatures. By tuning the infra-red energy to defect levels of specific energy, adequate stimulation of these defect levels is selectively achieved. This way, either or both electron or hole trapping at deep-level defects can be suppressed and the residence time of the trapped carriers can be reduced.

### SUMMARY OF THE INVENTION

The present invention is a method by which the residence time of charge carriers is dramatically reduced by an external optical energy source and the occupancy of deep-level defects is maintained close to the thermal equilibrium of the un-irradiated device at any temperature. The radiation detector has an external optical energy source to provide sufficient energy for trapped charged carriers to escape from defect levels and crystals that are transparent to the light of the energy source allowing no additional absorption.

In this method, instead of relying on thermal energy to release the trapped carriers, infra-red light radiation provides sufficient energy for the trapped carriers to escape from the defect levels. The energy of the infra-red light source is tuned within the band gap energy range, preferably corresponding to the ionization energy of the deep-level defects ˜0.5-0.8 eV.

The CdZnTe crystals are transparent to infra-red light of this energy and no additional absorption occurs other than the one associated with the ionization of the targeted deep-level defects. Because of this low absorption, the infra-red irradiation can be performed through any surface of the crystal that is transparent to the infra-red light. This conveniently allows irradiation geometry from side surface(s) of the CdZnTe detector crystals. The intensity of the infra-red radiation can be tuned to (1) maintain the thermal equilibrium occupancy of the deep-level defect without generating excessive photocurrent in the device from the infra-red radiation or (2) generate alternative steady-state occupations.

By suppressing electron and hole trapping and reducing the residence time of the trapped carriers, the low-flux x-ray and gamma-ray spectroscopic performance (i.e., resolution) of detector devices can be improved. In addition, the operating range of the CdZnTe detectors can be extended to lower temperatures.

The method increases both the yield of useful detector crystals from a given material-properties distribution of available crystals and the performance characteristics of then fabricated detector devices. Both of these are core improvements of CdZnTe radiation detector technologies and significantly improve performance and reduce manufacturing cost of the detectors.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a graph of the temperature dependence of the average residence time of a hole in an initially singly ionized trapping center located at 0.6 eV above the valence band edge; and

FIG. 2 is a representation of a low-flux ²⁴¹Am alpha spectra from a 2 mm thick planar CdZnTe detector at Tₛₑₙₛₒᵣ˜173 K with and without infra-red stimulation.

### DETAILED DESCRIPTION OF THE PREFERRED EMBODIMENT

For a better understanding of the present invention, together with other and further objects, advantages, and capabilities thereof, reference is made to the following disclosure and appended claims in connection with the above-described drawings.

A method is disclosed by which the residence time of the charge carriers is dramatically reduced by an external optical energy course and the occupancy of the deep-level defects is maintained close to the thermal equilibrium of the un-irradiated device at any temperature.

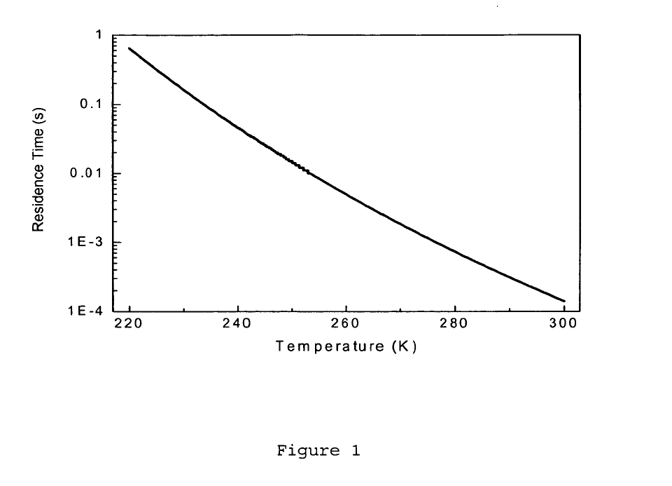

As shown in FIG. 1, a radiation detector that utilizes lower temperature operating conditions causes the emission rates of the trapped carriers from the defects back to the conduction or valence band to be dramatically reduced. A space charge can build up in the detector device even under low-flux conditions causing deterioration or collapsing of the spectral response.

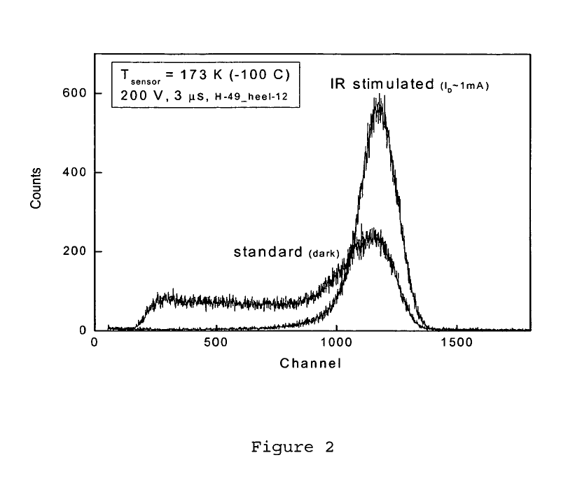

However, as shown in FIG. 2, under lower temperature operating conditions (e.g., for noise suppression) space-charge formation and collapsing spectra can be avoided and the detector operation can be recovered. In this particular cryostat setup, the actual detector temperature was not exactly known, but the dark (standard) spectrum started collapsing for bias voltages below ˜200 V.

Since other modifications and changes varied to fit particular requirements and environments will be apparent to those skilled in the art, the invention is not considered limited to the example chosen for the purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A radiation detector comprising:
an external optical energy source to provide sufficient energy for trapped charged carriers to escape from defect levels; and
crystals that are transparent to the light of the energy source allowing no additional absorption.

2. The radiation detector of claim 1, wherein the external optical energy source is an infra-red light source.

3. The radiation detector of claim 2, wherein the energy of the infra-red light source is tuned within the band gap energy range of ˜0.5-0.6 eV.

4. The radiation detector of claim 2, wherein the transparent crystals are made of Cadmium Zinc Telluride.

5. A method of detecting radiation comprising energy of an external infra-red light source tuned within the band gap energy range of ˜0.5-0.8 eV to interact with transparent crystals, the steps comprising:
a) causing the occupancy of the deep-level defects to be maintained close to the thermal equilibrium of the un-irradiated device at any temperature;
b) allowing trapped carriers to escape from the defect levels; and
c) causing the residence time of charge carriers to be dramatically reduced by the external infra-red energy source.
